(19) United States
(12) Patent Application Publication
(10) Pub. No.: US 2019/0349212 A1
(43) Pub. Date: Nov. 14, 2019

(54) REAL-TIME MEETING EFFECTIVENESS MEASUREMENT BASED ON AUDIENCE ANALYSIS

(71) Applicant: INTERNATIONAL BUSINESS MACHINES CORPORATION, ARMONK, NY (US)

(72) Inventors: Jennifer Heins, Raleigh, NC (US); Marshall A. Lamb, Raleigh, NC (US); Laura J. Rodriguez, Durham, NC (US)

(21) Appl. No.: 15/974,825

(22) Filed: May 9, 2018

(51) Int. Cl. H04L 12/18; G06K 9/00; H04L 29/08

(52) U.S. Cl. CPC H04L 12/1822; H04L 67/306; G06K 9/00302; H04L 12/1831

(57) ABSTRACT

A method, computer system, and a computer program product for evaluating an effectiveness of an electronic meeting based on real-time audience analysis is provided. The present invention may include receiving a participant data feed having at least one physical marker of a meeting participant. The present invention may include measuring the physical marker of each participant. The present invention may include deriving at least one initial audience metric associated with the participant. The present invention may include generating a baseline participant score for each participant based on the derived initial audience metric. The present invention may include evaluating the generated baseline participant score in view of at least one initial factor. The present invention may include generating a baseline meeting effectiveness score for the meeting by aggregating the evaluated baseline participant scores of a plurality of participants and displaying a graphic representation of the generated baseline meeting effectiveness score.

### BACKGROUND

The present invention relates generally to the field of computing, and more particularly to determining the effectiveness of an electronic meeting.

Electronic meetings have gained popularity due to their convenience and cost savings. Regardless of the meeting venue (e.g., in-person or electronic), a moderator must determine whether he or she is delivering an effective presentation. If the content or delivery of the presentation is ineffective, real-time adjustments may be necessary to improve the effectiveness of the presentation and get the purpose of the meeting back on track.

### SUMMARY

Embodiments of the present invention disclose a method, computer system, and a computer program product for automatically evaluating an effectiveness of an electronic meeting based on real-time audience analysis. The present invention may include receiving, from a device associated with each meeting participant of a plurality of meeting participants in an electronic meeting, a participant data feed having at least one physical marker of the respective meeting participant. The present invention may also include measuring the at least one physical marker of each meeting participant. The present invention may then include deriving, based on the measured at least one physical marker, at least one initial audience metric associated with the meeting participant. The present invention may further include generating a baseline participant score for each meeting participant based on the derived at least one initial audience metric associated with the meeting participant. The present invention may also include evaluating the generated baseline participant score of each meeting participant in view of at least one initial factor. The present invention may then include generating a baseline meeting effectiveness score for the electronic meeting by aggregating the evaluated baseline participant scores of the plurality of meeting participants. The present invention may further include displaying a graphic representation of the generated baseline meeting effectiveness score of the electronic meeting.

Embodiments of the present invention may include generating a graphical user interface having a presentation frame including a meeting content and at least one feedback component including the displayed graphic representation of the generated baseline meeting effectiveness score. The present invention may then include displaying the at least one feedback component simultaneously with the presentation frame.

Embodiments of the present invention may include evaluating the generated baseline participant score of each meeting participant comprising determining that the generated baseline participant score of the meeting participant is impacted by the at least one initial factor and adjusting a value of the generated baseline participant score of the meeting participant when aggregating the evaluated baseline participant scores of the plurality of meeting participants.

Embodiments of the present invention may include deriving a current participant score for each meeting participant based on at least one current audience metric associated with the respective meeting participant. The present invention may then include reevaluating a previous participant score of each meeting participant in view of the derived current participant score of the respective meeting participant. The present invention may also include determining an updated meeting effectiveness score for the electronic meeting by aggregating the reevaluated previous participant scores of the plurality of meeting participants.

Embodiments of the present invention may include adjusting the value of the generated baseline participant score of the meeting participant comprising adjusting a numerical value of the generated baseline participant score.

Embodiments of the present invention may include adjusting the value of the generated baseline participant score of the meeting participant comprising adjusting a weight value of the generated baseline participant score.

Embodiments of the present invention may include reevaluating the previous participant score of each meeting participant in view of the derived current participant score comprising comparing the previous participant score with the derived current participant score and determining a delta exceeding a pre-determined minimum delta threshold and substituting the previous participant score with the derived current participant score of the meeting participant when aggregating the reevaluated previous participant scores of the plurality of meeting participants.

Embodiments of the present invention may include reevaluating the previous participant score of each meeting participant in view of the derived current participant score comprising comparing the previous participant score with the derived current participant score and determining a delta exceeding a pre-determined significant delta threshold and adjusting a weight of the derived current participant score of the meeting participant when aggregating the reevaluated previous participant scores of the plurality of meeting participants.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for an electronic meeting moderator and participant registration according to at least one embodiment;

FIG. 3 is an operational flowchart illustrating a process for an electronic meeting audience analysis according to at least one embodiment;

FIG. 4 is an exemplary illustration of an electronic meeting graphical user interface according to at least one embodiment;

FIG. 5 is a block diagram of internal and external components of computers and servers depicted in FIG. 1 according to at least one embodiment;

FIG. 6 is a block diagram of an illustrative cloud computing environment including the computer system depicted in FIG. 1, in accordance with an embodiment of the present disclosure; and

FIG. 7 is a block diagram of functional layers of the illustrative cloud computing environment of FIG. 6, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for determining the effectiveness of an electronic meeting based on audience metrics (e.g., participation, sentiment, engagement) analysis of the electronic meeting participants (participants). As such, the present disclosure has the capacity to improve the technical field of electronic meetings by determining various audience metrics and graphically delivering the aggregated results in a quickly consumable manner to an electronic meeting moderator (moderator), so that the moderator may receive real-time audience feedback without having to divert attention away from the moderator's presentation.

More specifically, prior to the start of an electronic meeting, a participant profile may be initialized and stored in a server associated with the electronic meeting program such that the participant profile may be accessible when the participant joins the electronic meeting. Once the moderator starts the electronic meeting, connection may be established between the participants and the electronic meeting room. Thereafter, video and audio data of the participants may be gathered from their respective desktops, laptops, or mobile devices, and uploaded to the server for processing by the electronic meeting program. The video and audio data may then be parsed and associated with the stored participant profiles to identify each meeting participant using known facial recognition techniques. Next, the video and audio data for each participant may be analyzed to identify one or more physical markers. Cognitive inferencing capabilities may then be applied to analyze the identified physical markers to derive each participant's baseline participant score, comprising their initial participation or attention span level and their initial sentiment. If the participant's baseline participant score is influenced by additional factors, the participant's baseline participant score may be adjusted or weighted accordingly. Thereafter, if there are multiple participants, the participants' baseline participant scores may be aggregated to determine a baseline meeting effectiveness score which may then be rendered graphically onto the moderator's display. During the course of the electronic meeting, each participant may be continuously tracked to determine if their participant score changes substantially (higher or lower) from their previous participant score. The change or delta in the participant score may result in adjusting the weight of the participant's score towards subsequent calculations of the meeting effectiveness score. It is contemplated that adjusting the weight of individual participant scores, when necessary, may provide a more nuanced and accurate determination of the meeting effectiveness score.

As described previously, electronic meetings have gained popularity due to their convenience and cost savings. Regardless of the meeting venue (e.g., in-person or electronic), the moderator must determine whether he or she is delivering an effective presentation. If the content or delivery of the presentation is ineffective, real-time adjustments may be necessary to get the purpose of the meeting back on track. During in-person meetings, the moderator has the ability to gauge the effectiveness of the meeting or presentation by observing the body language of the audience. For example, being able to see audience members turn to their phones, yawn, fidget, or nod off to sleep may provide invaluable real-time feedback to the moderator that he or she is losing the audience's attention span, that the content or delivery of the presentation is ineffective, and that adjustments need to be made to quickly get the purpose of the meeting back on track. With electronic meetings, the moderator may not be physically present in a conference room or an auditorium and thus unable to scan the audience to observe their body language. Many electronic meeting services provide the moderator with live video and audio feed of the meeting room attendees using the attendees' desktops, laptops, or mobile devices. When there are numerous participants, it may be difficult for the moderator to view all of the feeds on a single screen without techniques such as scrolling or tiling. However, if the moderator is sharing a presentation or their screen, it may be difficult for them to divert their attention to another screen to scroll or tile through the numerous participant feeds in order to ascertain real-time audience engagement levels.

Therefore, it may be advantageous to, among other things, provide a way to determine various audience metrics and graphically deliver the aggregated results in a quickly consumable manner to the moderator's display, so that the moderator may receive real-time audience feedback (e.g., in order to make adjustments to the style, tempo, and detail level of the presentation) without having to divert attention away from the moderator's presentation.

According to at least one embodiment, video image and audio feed recognition and analysis may be combined with cognitive inferencing capabilities to judge a participant's attention span, interest, and emotional state during an electronic meeting. Since many electronic meeting services or programs process the video and audio feeds centrally before distributing the data to the various meeting clients, the central processing may provide an opportunity to analyze the audio and video feeds for physical markers or indicators of the participant's expression, emotion, body language, and position. These physical markers may then be analyzed using cognitive inferencing services to derive numeric values for audience metrics such as, for example, attention span, interest level, and emotional state. In embodiments, the audience metrics may be applied to a data model representing the engagement level of each electronic meeting participant. The data model may contain several engagement vectors, such as, for example, excitement, mood, attention span, agreement, and comprehension. Each vector may have a value along a positive/negative scale, for example, 1 being most negative and 20 being most positive. The numeric scale of each engagement vector may used to provide visual feedback to the moderator, in the form of graphical meters. In embodiments, the engagement vectors may be averaged to derive an overall engagement level score for each participant. The engagement level scores may then be aggregated across all participants and summarized into a real-time engagement meter for the moderator or presenter. There may be several graphical meters, providing information on a number of different audience metrics, such as, for example, attention span and emotional state.

In embodiments, it is contemplated that the participant's score may be influenced by several additional factors which may result in adjusting the weight of the participant's score. The higher the weight of the score, the more the score may factor into the overall meeting effectiveness score. Likewise, the lower the weight of the score, the less it may factor into the overall meeting effectiveness score. In embodiments, these factors may include: an exposure factor, where the participant has seen the material before, either through viewing, downloading, or participating in another presentation that included the same material, in which case, the participant's score may be given lower weight; a participation delta factor, where a substantially different (higher or lower) meeting participant score is detected over what is known to be the participant's baseline score; an influencer factor, where the moderator is a largely recognized leader or authority, in which case each participant's baseline score may automatically be increased, requiring a larger participant delta factor to increase the weight of the individual's score; a proximity factor, where participants in the same physical room as the moderator may have a lower weight attributed to their participant score, given the likelihood of higher participation when in the same room as the moderator; a time zone factor, where participants in a vastly different time zone than the moderator (such as in the middle of the night) may have a lower weight attributed to their participant score as an unlikely active participant; and a mood factor, where the overall mood of the participant may be learned based on recent activity (instant messages, social media activity, and prior meetings), and the initial weight of their score may be lowered as less likely to be different from their prior mood-however, the weight of their score may be increased if their participant delta factor increases during the course of the meeting.

According to at least one embodiment, machine learning may be applied at the individual participant level to both observe the individual's participation level over time and determine which factors influence the individual's participation level most often, continually adjusting the individual's baseline participation score as a result.

According to at least one embodiment, the moderator may be provided with specific prompts or feedback based on audience body language indicators. For example, if a participant tilts their head to the side, the cognitive system may infer confusion, and the moderator may be prompted to explain the concept further. If a participant raises their eyebrows, the cognitive system may infer positive engagement, and the moderator may be notified that the content is being positively received. If a participant starts rubbing their chin, the cognitive system may infer that the participant is thinking deeply about something, and the moderator may be prompted to ask if the participant has a question or comment. If a participant sighs, yawns, walks away from their computer for an extended period of time, turns to their phone, or otherwise looks away (including nodding off to sleep), the cognitive system may infer that the participant is bored and losing interest, and the moderator may be prompted to change the pace, style, or focus of the presentation to increase interest. If a participant provides a verbal reaction such as “huh!” or “huh?”, the cognitive system may infer either excitement or question, and the moderator may be prompted as appropriate.

In one embodiment, the meeting participants may provide explicit feedback to improve the accuracy of the cognitive system over time. Specifically, the cognitive system may use the explicit feedback to learn whether the system's inferences regarding the meeting participant's attention span, interest level, and emotional state were accurate. The cognitive system may be able to associate an individual's explicit feedback on the electronic meeting with the inferred feedback the cognitive system derived for that same individual. In embodiments, the cognitive system may gather such explicit feedback through one or more of the following: an end of meeting survey, in-meeting feedback buttons (allowing participants to provide real-time feedback of their interest level), and observing the participant's desktop behavior (e.g., frequently navigating away from the electronic meeting screen).

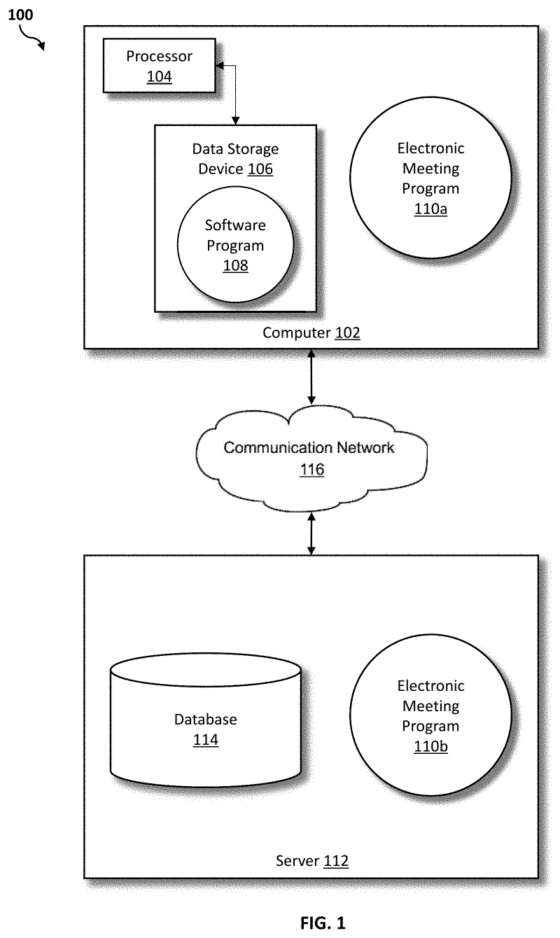

Referring to FIG. 1, an exemplary networked computer environment 100 in accordance with one embodiment is depicted. The networked computer environment 100 may include a computer 102 with a processor 104 and a data storage device 106 that is enabled to run a software program 108 and an electronic meeting program 110a. The networked computer environment 100 may also include a server 112 that is enabled to run an electronic meeting program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

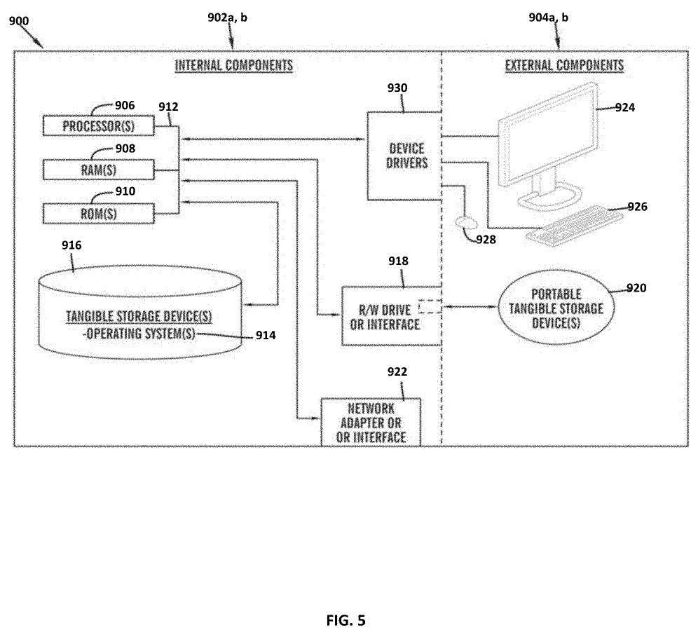

The client computer 102 may communicate with the server computer 112 via the communications network 116. The communications network 116 may include connections, such as wire, wireless communication links, or fiber optic cables. As will be discussed with reference to FIG. 5, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the electronic meeting program 110a, 110b may interact with a database 114 that may be embedded in various storage devices, such as, but not limited to a computer/mobile device 102, a networked server 112, or a cloud storage service.

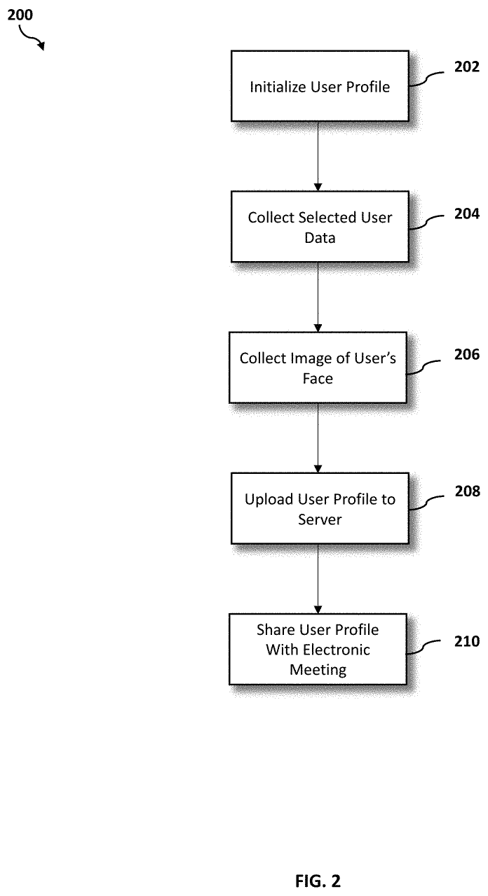

According to the present embodiment, a first user or electronic meeting moderator (moderator) using a first client computer 102 or server computer 112 may use the electronic meeting program 110a, 110b (respectively) to determine the effectiveness of an electronic meeting based on various audience metrics analysis of a second user or electronic meeting participant (participant) using the electronic meeting program 110a on a second client computer 102. The method of determining the effectiveness of an electronic meeting based on various audience metrics analyses and graphically delivering the results is explained in more detail below with reference to FIGS. 2-4.

Referring now to FIG. 2, an operational flowchart illustrating the exemplary moderator and participant registration process 200 used by the electronic meeting program 110a, 110b according to at least one embodiment is depicted.

At 202 a user profile is initialized. Using a software program 108 on the moderator's device (e.g., first client computer 102), a moderator profile corresponding with the moderator-user of the device (e.g., desktop) may be initialized. Also, using a software program 108 on the participant's device (e.g., second client computer 102), a participant profile corresponding with the participant-user of the device (e.g., laptop) may be initialized. The initialized profile may be a data file for storing one or more images, user preferences, and other relevant data. The user profile may be implemented as a data structure with fields containing user data or pointers to user data.

For example, a user may interact with a laptop (e.g., client computer 102) and start the electronic meeting program 110a, 110b. The electronic meeting program 110a, 110b may automatically present the user with the option to create a new moderator or participant profile, if none is found, or may display a button or other way for the user to indicate a desire to create a new moderator or participant profile. Once the user affirmatively indicates a desire to create a moderator or participant profile, a new data structure (e.g., an array) may be initialized for the chosen profile. The electronic meeting program 110a, 110b may also present the user with the option to create a guest moderator or participant profile if the user is not a routine user of the electronic meeting program 110a, 110b and will only be a guest in a particular electronic meeting.

Next, at 204, user selected data are collected. After initializing the user profile at 202, the electronic meeting program 110a, 110b may collect user data and preferences by presenting prompts or questions to the user that the user may reply to by, for example, entering text or selecting from a predetermined list of answers. In embodiments, the user may be prompted to create a password to secure the user profile. In embodiments, questions may be presented to the user including security questions to reset the user's password (if needed) as well as questions to determine the user's job title, contact information (e.g., E-mail address), and geographic location. Additionally, the user may be prompted to select the video and audio devices that the user will be using during the electronic meeting or prompted to allow the electronic meeting program 110a, 110b to detect the video and audio devices automatically. The user password, answers from the questions, and any other user preferences may then be stored using the initialized user profile data structure. In embodiments, if the user is creating a guest moderator or participant profile, the user may not be prompted to create a password or answer security questions.

For instance, the electronic meeting program 110a, 110b may prompt the user to enter via text, the user's job title, contact information, and geographic location. In response, the user may textually enter: “associate attorney,” “John.Doe@lawfirm.com,” and “New York,” respectively.

Then, at 206, an image of the user's face is collected. The user may be given the option to select a preexisting image of the user's face or a camera attached to the client computer 102 (e.g., a front-facing camera on a laptop) may be accessed by the electronic meeting program 110a, 110b to collect an image of the user's face. Additional images of the user's face may be taken or selected to more clearly identify the user (or to better identify the user from different angles) depending on known facial recognition techniques employed by the electronic meeting program 110a, 110b. Furthermore, the user may be given an option to indicate that a picture taken is satisfactory and given the opportunity to retake the picture of the user's face if the user finds the picture unsatisfactory. After the image(s) of the user's face have been collected, the image(s) may be added to the user profile.

For example, the user may elect to take images using the front-facing camera on the user's laptop. The electronic meeting program 110a, 110b may then collect three images of the user's face (e.g., front, left-profile, and right-profile) and add the three images to the user's profile in any suitable image format.

At 208, the user profile is uploaded to a server 112. After the user profile is complete, the user profile may be uploaded, for example, to a cloud environment for storage on a server 112 via network 116. The user profile may be transmitted from the user's device (e.g., laptop) by the electronic meeting program 110a, 110b to a central server 112 where the user profile may be accessed by the electronic meeting program 110a, 110b. On the server 112, the user profiles may be stored within a data repository, such as database 114.

At 210, the user profile is shared with an electronic meeting. The profiles stored in one or more servers 112 may be accessed by the electronic meeting program 110a, 110b and shared with a specific electronic meeting. The user profile may be sent by the electronic meeting program 110a, 110b to a specific electronic meeting when the user (e.g., moderator) starts an electronic meeting or when the user (e.g., participant) joins an electronic meeting.

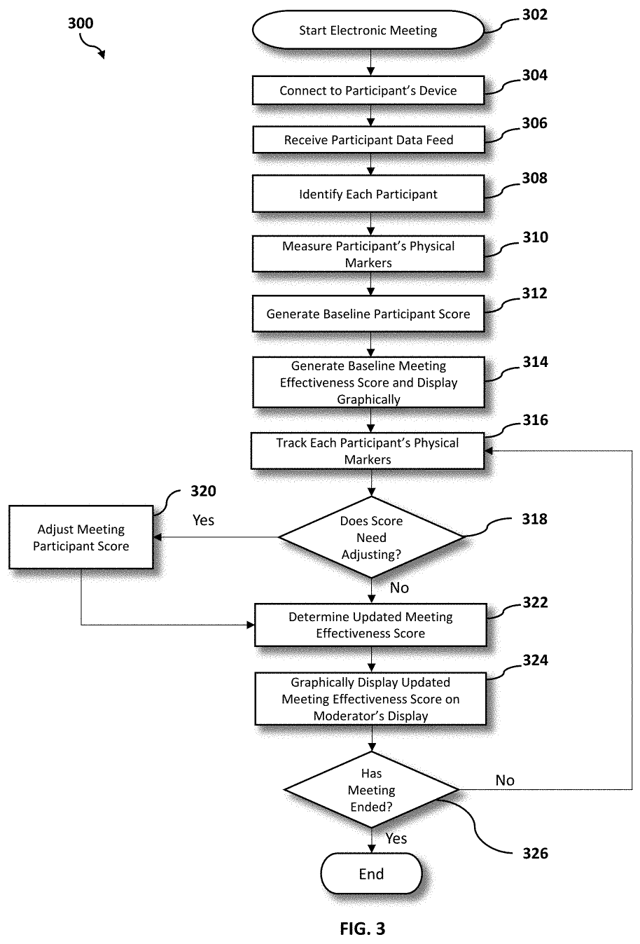

Referring now to FIG. 3, an operational flowchart illustrating the exemplary audience analysis process 300 used by the electronic meeting program 110a, 110b according to at least one embodiment is depicted.

At 302, an electronic meeting is started. A moderator-user using their device (e.g., desktop) and the electronic meeting program 110a, 110b, may create an electronic meeting room and start an electronic meeting. For example, if a user who previously created and saved a moderator profile to server 112 starts an electronic meeting, the electronic meeting program 110a, 110b may access the moderator profile from server 112 and share the moderator profile with the electronic meeting room. If no moderator profile is detected for the user, the electronic meeting program 110a, 110b may prompt the user to create a moderator profile as previously described with reference to FIG. 2. Once the electronic meeting room is created, the moderator may upload a presentation or other materials that is to be shared with one or more participants of the electronic meeting.

At 304, connection is established between the participant's device and the electronic meeting. Once the electronic meeting is started by the moderator, a participant-user running the electronic meeting program 110a, 110b on the participant-user's device (e.g., laptop) may join the electronic meeting room as a participant. For example, when a user runs the electronic meeting program 110a, 110b, the electronic meeting program 110a, 110b may prompt the user to join an electronic meeting by entering text or selecting an electronic meeting from a list of electronic meetings that have been started. In embodiments, the electronic meeting program 110a, 110b may gather data from the participant's linked electronic calendar that indicates that the participant is scheduled to attend an electronic meeting and automatically prompt the participant to join the electronic meeting room associated with the participant's scheduled meeting.

Next, at 306, the electronic meeting program 110a, 110b receives a participant data feed, including video and audio data from each of the participants. After the participants join the electronic meeting, the electronic meeting program 110a, 110b may receive, via communication network 116, video and audio feed from each participant's device (e.g., laptop's camera and microphone). For example, the electronic meeting program 110a, 110b may receive, via communication network 116, streaming video and audio data in a predefined format from the laptop of a participant P₁ of the electronic meeting for capturing participant P₁'s physical markers.

At 308, each electronic meeting participant is identified. Using known facial recognition methods, the participant's face may be tracked using the participant's device (e.g., laptop's camera) and identified using one or more images of the participant's face saved in the participant's profile. For example, if the electronic meeting has ten participants, the electronic meeting program 110a, 110b may establish a connection with each participant's device so that each participant's video feed may be analyzed using known facial recognition methods and compared with all the participant profile images stored in server 112 to identify the ten individual participants (P₁-P₁₀) in the current electronic meeting. In embodiments, each participant's device (e.g., laptop) may send a unique identifier (e.g., user name) corresponding with each participant to the electronic meeting program 110a, 110b and thereafter, the electronic meeting program 110a, 110b may retrieve the identified participant profile from server 112.

Then at 310, the physical markers of each electronic meeting participant are measured. During a first pass through the audience analysis process 300, the electronic meeting program 110a, 110b may utilize known facial recognition methods to identify each participant's physical markers. Then, the electronic meeting program 110a, 110b may apply cognitive inferencing or analytics techniques to analyze and measure the participant's identified physical markers to derive numeric values for various initial audience metrics, such as, initial participation or attention level and initial sentiment or emotional state.

In embodiments, the electronic meeting program 110a, 110b may analyze a participant's video and audio feed to identify physical markers, for example, in the participant's facial expressions, facial movements, body language, and voice, to determine the participant's initial participation level and sentiment or emotional state. For example, if soon after the start of the electronic meeting, participant P₁ is looking into the screen of participant P₁'s device (e.g., laptop) while smiling and participant P₂ is slouched, frowning, and looking away from the screen of participant P₂'s device (e.g., laptop), the electronic meeting program 110a, 110b may track the video feed of each participant P₁, P₂ and identify physical markers from the eye contact, facial expression, and body language of each participant P₁, P₂ using known facial recognition methods.

Once the electronic meeting program 110a, 110b identifies participant P₁'s physical markers from participant P₁'s eye contact and smiling facial expression, the electronic meeting program 110a, 110b may use cognitive inferencing techniques to translate the eye contact and smiling facial expression and determine that participant P₁ is paying attention to the electronic meeting and is in a good mood. Similarly, the electronic meeting program 110a, 110b may use cognitive inferencing techniques to translate participant P₂'s lack of eye contact, frowning facial expression, and slouched body position and determine that participant P₂ is not paying attention to the electronic meeting and is in a bad mood. In embodiments, the electronic meeting program 110a, 110b may then use cognitive inferencing techniques to measure the participant's physical markers and derive a numeric value along a positive/negative scale (e.g., 1 being most negative and 20 being most positive) for each participant's participation level and sentiment.

For example, given participant P₁'s identified physical markers, the electronic meeting program 110a, 110b may derive that participant P₁ has a score of 14 out of 20 for initial participation and a score of 16 out of 20 for initial sentiment. Similarly, given participant P₂'s identified physical markers, the electronic meeting program 110a, 110b may derive that participant P₂ has a score of 2 out of 20 for initial participation and a score of 4 out of 20 for initial sentiment.

Next at 312, a baseline participant score is generated for each meeting participant. The electronic meeting program 110a, 110b may generate a baseline participant score for each participant by calculating the average of the participant's initial participation and sentiment level gathered from the participant's identified physical markers.

For example, based on the measurements gathered at 310, the electronic meeting program 110a, 110b may determine that participant P₁, with a score of 14 out of 20 for initial participation and a score of 16 out of 20 for initial sentiment, has a baseline participant score of 15 out of 20. Similarly, the electronic meeting program 110a, 110b may determine that participant P₂, with a score of 2 out of 20 for initial participation and a score of 4 out of 20 for initial sentiment, has a baseline participant score of 3 out of 20.

In embodiments, once the baseline participant scores are generated, the electronic meeting program 110a, 110b may evaluate the baseline participant scores in view of various initial participant impact factors (initial factors) and adjust the value of the baseline participant scores accordingly, when calculating a baseline meeting effectiveness score. Specifically, if the electronic meeting program 110a, 110b determines that initial factors beyond the contents and delivery of the electronic meeting may have impacted a participant's initial participation and sentiment level scores, the electronic meeting program 110a, 110b may adjust the value of the participant's baseline participant score by, for example, adjusting the participant's baseline participant score or by adjusting the weight that will be given to the participant's baseline participant score towards the calculation of the baseline meeting effectiveness score. The amount by which the value of a participant's baseline participant score is adjusted for a given initial factor may be set based on moderator preference entered through the electronic meeting program 110a, 110b. In embodiments, the amount may be set by analyzing historical data collected by the electronic meeting program 110a, 110b that indicates the optimal adjustments that need to be made to the baseline participant scores to provide the moderator with nuanced feedback based only on the contents and delivery of the electronic meeting.

According to at least one embodiment, initial factors that may trigger the electronic meeting program 110a, 110b to adjust a participant's baseline participant score or the weight thereof include, for example, an exposure factor, an influencer factor, a proximity factor, a time zone factor, and a mood factor.

An exposure factor may trigger the electronic meeting program 110a, 110b to decrease the weight of a participant's baseline score if the participant was previously exposed to the contents of the electronic meeting, either through viewing, downloading, or participating in another presentation with the same material. By deemphasizing the baseline participant scores of participants with prior exposure to an electronic meeting's contents, the electronic meeting program 110a, 110b may provide the moderator with more nuanced feedback based only on the contents and delivery of the current electronic meeting.

For example, when an electronic meeting has four meeting participants (P₁-P₄), the default weight of each participant's baseline participant score may be 25% of the baseline meeting effectiveness score. However, if participant P₁ previously attended the same electronic meeting, the electronic meeting program 110a, 110b may identify data in the data storage device 106 of participant P₁'s device (e.g., laptop) or in the meeting attendance history associated with participant P₁'s participant profile that indicates that participant P₁ was previously exposed to the contents of the current electronic meeting. As a result, the electronic meeting program 110a, 110b may decrease the weight of participant P₁'s baseline participant score by 15% (from 25% to 10%) and correspondingly increase the total weight of the remaining three meeting participants' (P₂, P₃, P₄) baseline participant scores by 15%, for example, by 5% each (from 25% to 30%).

An influencer factor may trigger the electronic meeting program 110a, 110b to automatically increase a participant's baseline participant score if the moderator of the electronic meeting is a largely recognized leader or authority in relation to the participant. When the moderator is an influential person, it is contemplated that the participant's baseline participant score may be impacted by the moderator's recognition and importance. The electronic meeting program 110a, 110b may compensate for the moderator's name recognition by increasing the participant's baseline participant score. By raising the participant's baseline participant score, the participant's subsequent participant score would need to be significantly higher than the participant's increased baseline participant score in order to increase the weight of the participant's score towards the calculation of a subsequent, updated meeting effectiveness score.

For example, when the moderator of an electronic meeting is the Chief Executive Officer of company X and the four meeting participants (P₁-P₄) are junior analysts in company X, the electronic meeting program 110a, 110b may analyze the organizational chart and hiring structure of company X and determine this professional hierarchy between the moderator and the four participants (P₁-P₄). Due to the moderator's professional authority over the four participants (P₁-P₄) in company X, the electronic meeting program 110a, 110b may increase each participant's baseline participant score by two points. For example, if participants P₁, P₂ each had a pre-adjusted baseline participant score of 10 out of 20, the electronic meeting program 110a, 110b may increase each of their baseline participant scores to 12 out of 20. Similarly, if participants P₃, P₄ each had a pre-adjusted baseline participant score of 11 out of 20, the electronic meeting program 110a, 110b may increase each of their baseline participant scores to 13 out of 20. As such, participants P₁, P₂ would need to achieve a subsequent participant score that is significantly higher than 12 out of 20 and participants P₃, P₄ would need to achieve a subsequent participant score that is significantly higher than 13 out of 20 in order to increase the weight of that participant's score towards the calculation of the subsequent, updated meeting effectiveness score.

A proximity factor may trigger the electronic meeting program 110a, 110b to decrease the weight of a participant's baseline score if the participant is attending the electronic meeting in the same physical room (e.g., auditorium) as the moderator of the electronic meeting, while another participant is attending the electronic meeting remotely. When the moderator is in the same room as the participant, it is contemplated that the participant's baseline participant score may be impacted by the physical presence of the moderator. That is, the participant may likely be more active (e.g., higher participant score) in the electronic meeting due to the moderator's physical presence. By deemphasizing the baseline participant scores of participants that are in the same room as the moderator, the electronic meeting program 110a, 110b may provide the moderator with more nuanced feedback based only on the contents and delivery of the electronic meeting.

The electronic meeting program 110a, 110b may determine and compare the geographic locations of the moderator and the participants based on the location data saved in the moderator and participant profiles, respectively. In embodiments, the electronic meeting program 110a, 110b may also detect the moderator's device (e.g., desktop) and each participant's device (e.g., laptop) at a location using known methods such as querying the Global Positioning System (GPS) coordinates of each device, Bluetooth® (Bluetooth and all Bluetooth-based trademarks and logos are trademarks or registered trademarks of Bluetooth SIG, Inc. and/or its affiliates) or Wi-Fi connectivity with each device, or using near-field communication (NFC).

For example, if the moderator of an electronic meeting and participants P₁, P₂ are in the same room, while participants P₃, P₄ are attending the electronic meeting remotely, the electronic meeting program 110a, 110b may detect that participants P₁, P₂ are in the same geographic location as the moderator by comparing the GPS coordinates of participants P₁, P₂ against the GPS coordinates of the moderator. Accordingly, the electronic meeting program 110a, 110b may decrease the weight of the baseline participant scores of each participant P₁, P₂ by 5% (from 25% to 20%) and increase the weight of the baseline participant scores of each participant P₃, P₄ by 5% (from 25% to 30%). Thus, any increase in the activity of participants P₁, P₂ due to the physical presence of the moderator may be deemphasized by the electronic meeting program 110a, 110b prior to calculating the baseline meeting effectiveness score.

In embodiments, a time zone factor may trigger the electronic meeting program 110a, 110b to decrease the weight of a participant's baseline participant score if the participant is in a vastly different time zone than the moderator, such that the participant is attending the electronic meeting at an unusual time given the participant's past activity (e.g., in the middle of the night). When the time zone between the participant and the moderator is vastly different, it is contemplated that the participant is unlikely to be an active participant due to the timing of the electronic meeting, rather than the quality of the moderator's presentation.

For example, if a moderator is hosting an electronic meeting in New York at 3:00 P.M. local time with four participants (P₁-P₄), where participants P₁, P₂, P₃ are attending remotely from New York and participant P₄ is attending remotely from Dhaka, Bangladesh, the electronic meeting program 110a, 110b may read the time stamp from the respective devices of the moderator and participants P₁, P₂, P₃ and determine that the local time of the moderator and participants P₁, P₂, P₃ is 3:00 P.M. Similarly, the electronic meeting program 110a, 110b may read the time stamp from participant P₄'s device and determine that participant P₄'s local time is 1:00 A.M. the following day. Thereafter, the electronic meeting program 110a, 110b may calculate the ten-hour time difference between the moderator's local time and participant P₄'s local time and decrease the weight of participant P₄'s baseline participant score by 15% (from 25% to 10%) and increase the total weight of the remaining three meeting participants' (P₁, P₂, P₃) baseline participant scores by 15%, for example, by 5% each (from 25% to 30%). Thus, any decrease in the activity of participant P₄ due to the unusual local time (1:00 A.M.) of the electronic meeting may be deemphasized by the electronic meeting program 110a, 110b prior to calculating the baseline meeting effectiveness score.

In embodiments, the initial mood of an electronic meeting's participant may be learned based on recent internet activity (e.g., instant messages, social media, prior electronic meetings) and a mood factor may trigger the electronic meeting program 110a, 110b to decrease the weight of the participant's baseline participant score as being less likely to be different from the participant's initial mood.

For example, if the moderator is hosting an electronic meeting with four participants (P₁-P₄), where participant P₁ is an angry customer and participants P₂, P₃, P₄ are neutral customers, the electronic meeting program 110a, 110b may retrieve data from internet communications (e.g., E-mail) between the moderator and participant P₁ that indicates that participant P₁ is unhappy with the moderator's product. As such, the electronic meeting program 110a, 110b may decrease the weight of participant P₁'s baseline participant score by 15% (from 25% to 10%) and increase the total weight of the remaining three participants' (P₂, P₃, P₄) baseline participant scores by 15%, for example, by 5% each (from 25% to 30%). By deemphasizing the baseline participant score of participant P₁-who joined the electronic meeting with a prior bad mood—the electronic meeting program 110a, 110b may provide the moderator with more nuanced feedback based only on the contents and delivery of the electronic meeting. However, if participant P₁ achieves significantly higher subsequent participant scores, the electronic meeting program 110a, 110b may emphasize the change in participant P₁'s participant score and provide positive feedback to the moderator.

Thus at 312, the electronic meeting program 110a, 110b may derive a participant's baseline participant score by averaging the participant's initial participation and sentiment level scores. Further at 312, if the electronic meeting program 110a, 110b evaluates the participant's baseline participant score and determines that any initial factors (e.g., exposure factor, influencer factor, proximity factor, time zone factor, and mood factor) beyond the contents and delivery of the electronic meeting may have impacted the participant's initial participation and sentiment level scores, the electronic meeting program 110a, 110b may adjust the value of the participant's baseline participant score by adjusting the participant's baseline participant score or by adjusting the weight that will be given to the participant's baseline participant score towards the calculation of the baseline meeting effectiveness score. In embodiments, if one participant triggers multiple initial factors or if multiple participants trigger one of the initial factors, the electronic meeting program 110a, 110b may adjust the respective baseline participant scores or the weight of the respective baseline participant scores accordingly. The electronic meeting program 110a, 110b may then record the participant's baseline participant score in the participant's user profile in database 114.

Then at 314, a baseline meeting effectiveness score is determined, and the result is graphically displayed for the moderator. The electronic meeting program 110a, 110b may aggregate the baseline participant scores of a group of participants to determine the baseline meeting effectiveness score. Thereafter, the electronic meeting program 110a, 110b may send the resulting baseline meeting effectiveness score to the moderator's device (e.g., desktop) via communication network 116, and render the numeric value of the baseline meeting effectiveness score into a graphical representation of the score (e.g., graphic meter) on the moderator's display.

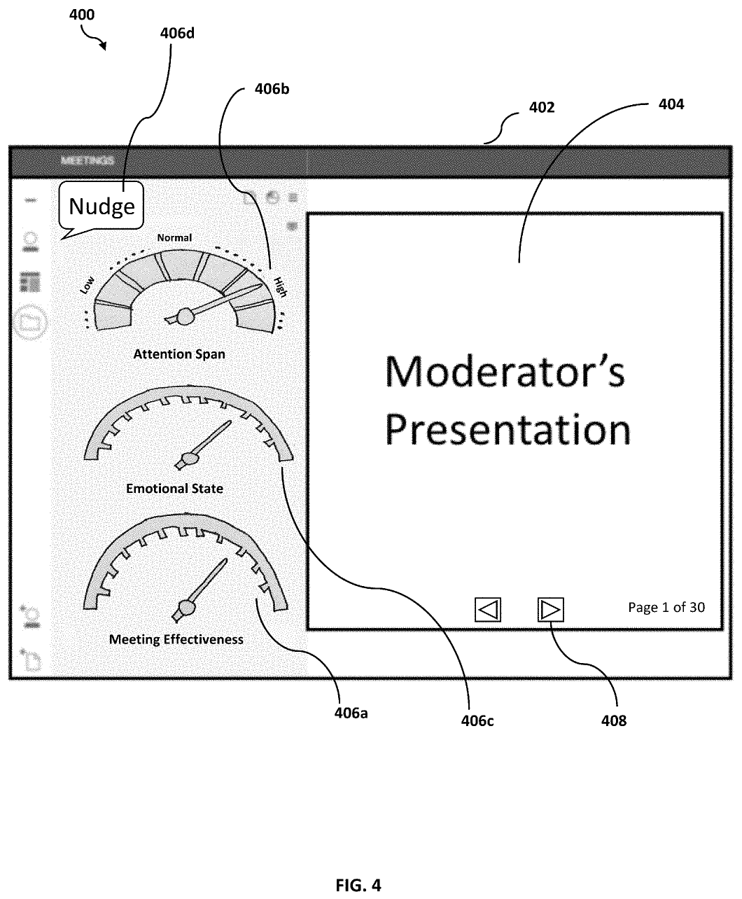

For example, if an electronic meeting includes four participants (P₁-P₄), where participant P₁ has a baseline participant score of 10 out of 20 (weighted at 10%), participant P₂ has a baseline participant score of 15 out of 20 (weighted at 30%), participant P₃ has a baseline participant score of 12 out of 20 (weighted at 30%), and participant P₄ has a baseline participant score of 14 out of 20 (weighted at 30%), the electronic meeting program 110a, 110b may aggregate the baseline participant scores of the four participants to determine a baseline meeting effectiveness score of 13.3 out of 20. Thereafter, the electronic meeting program 110a, 110b may send the 13.3 out of 20 baseline meeting effectiveness score to the moderator's device (e.g., desktop) via communication network 116, and render the numeric value of 13.3 out of 20 into a graphical meter (e.g., needle gauge) on the moderator's display, as described with reference to FIG. 4. In embodiments, if the baseline meeting effectiveness score includes a fractional component, the score may be rounded to the nearest integer (e.g., 13.3 to 13) to fit the scale of a graphical meter.

Then at 316, the physical markers of each electronic meeting participant are tracked and measured again to determine the participant's current audience metrics. Similar to the process at 310, the electronic meeting program 110a, 110b may utilize known facial recognition methods to track the participant's current physical markers and apply cognitive inferencing or analytics techniques to analyze and measure the participant's identified physical markers to derive numeric values for various current audience metrics, such as, current participation or attention level and current sentiment or emotional state. The electronic meeting program 110a, 110b may then derive a current participant score of the participant.

For example, if participant P₁'s current physical markers are determined to indicate that participant P₁ is engaged in the electronic meeting and in a good mood, cognitive inferencing or analytics techniques may derive that participant P₁ currently has a participation level score of 14 out of 20 and a sentiment level score of 16 out of 20. Averaging these scores, the electronic meeting program 110a, 110b may determine that participant P₁ now has a participant score of 15 out of 20.

At 318, the electronic meeting program 110a, 110b determines if a participant's previous participant score needs to be adjusted in view of the participant's current participant score. During the first pass through the audience analysis process 300, the participant's previous participant score, as recorded in database 114, may be the participant's baseline participant score, and during subsequent passes through the audience analysis process 300, the participant's previous participant score, as recorded in database 114, may be the participant's subsequent participant score. When reevaluating the participant's previous (e.g., baseline or subsequent) participant score, the electronic meeting program 110a, 110b may determine that the participant's previous participant score needs to be adjusted in view of the participant's current participant score, if the participant's current participant score (measured at 316) is higher or lower than the participant's previous participant score.

In embodiments, the electronic meeting program 110a, 110b may include a minimum delta threshold requirement for executing the adjustment in participant scores. In such embodiments, the electronic meeting program 110a, 110b may compare a participant's previous participant score with the participant's current participant score to determine if the change or delta between the two participant scores meets or exceeds the pre-defined minimum delta threshold.

The minimum delta threshold may be set based on the moderator's preference and entered through the electronic meeting program 110a, 110b. In instances, the electronic meeting program 110a, 110b may also present the moderator with the option to select an optimized minimum delta threshold. The electronic meeting program 110a, 110b may derive the optimized minimum delta threshold by analyzing historical data collected by the electronic meeting program 110a, 110b and recorded in database 114 to identify the minimum delta threshold that historically provided accurate and nuanced audience feedback to the moderator.

For example, if participant P₁ had a baseline participant score of 3 out of 20 as recorded in database 114, and at 316, the electronic meeting program 110a, 110b determines that participant P₁ has a current participant score of 15 out of 20, the electronic meeting program 110a, 110b may compare participant P₁'s baseline participant score with participant P₁'s current participant score and determine that participant P₁'s baseline participant score needs to be adjusted to reflect participant P₁'s current participant score. In embodiments, if the electronic meeting program 110a, 110b includes a minimum delta threshold requirement, which is set to +/−2 out of 20 based on the moderator's preference, the electronic meeting program 110a, 110b may compare the actual delta (e.g., 12 out of 20) between participant P₁'s baseline participant score (e.g., 3 out of 20) and participant P₁'s current participant score (e.g., 15 out of 20) and determine that the minimum delta threshold is exceeded. Accordingly, the electronic meeting program 110a, 110b may determine that participant P₁'s baseline participant score needs to be adjusted to reflect participant P₁'s current participant score.

If at 318, the electronic meeting program 110a, 110b determines that a participant's previous participant score needs to be adjusted to reflect the participant's current participant score, the electronic meeting program 110a, 110b may adjust the participant's previous participant score at 320. Once the participant's previous participant score is adjusted, the adjusted participant score may be recorded in database 114. The electronic meeting program 110a, 110b may adjust the participant's previous participant score by increasing or decreasing the previous participant score to reflect the participant's current participant score.

For example, if at 318, the electronic meeting program 110a, 110b determines that participant P₁'s previous participant score of 3 out of 20 needs to be adjusted to reflect participant P₁'s current participant score of 15 out of 20, then at 320, the electronic meeting program 110a, 110b may increase the participant's previous participant score by 12 points to reflect participant P₁'s current participant score of 15 out of 20. Thereafter, the electronic meeting program 110a, 110b may record the adjusted participant score of 15 out of 20 in database 114.

Further at 320, if the electronic meeting program 110a, 110b determines that the participant's current participant score is significantly different (higher or lower) than the participant's previous participant score, the electronic meeting program 110a, 110b may be triggered by a participation delta factor to increase the weight (i.e., delta factor weight) of the participant's current participant score towards the calculation of the updated meeting effectiveness score. The electronic meeting program 110a, 110b may be triggered by the participation delta factor if the change or delta between the participant's previous participant score and the participant's current participant score meets or exceeds a pre-defined significant delta threshold.

The significant delta threshold may be set based on the moderator's preference and entered through the electronic meeting program 110a, 110b. In instances, the electronic meeting program 110a, 110b may also present the moderator with the option to select an optimized significant delta threshold. The electronic meeting program 110a, 110b may derive the optimized significant delta threshold by analyzing historical data collected by the electronic meeting program 110a, 110b and recorded in database 114 to identify the significant delta threshold that historically provided accurate and nuanced audience feedback to the moderator. The delta factor weight increase that will be given to the participant's current participant score if the score meets or exceeds the significant delta threshold may also be set based on the moderator's preference or based on historical data analyzed by the electronic meeting program 110a, 110b.

For example, a moderator may select a significant delta threshold of +/−5 out of 20 points with a delta factor weight increase of 10% based on historical data analyzed by the electronic meeting program 110a, 110b. If participant P₁ had a previous participant score of 3 out of 20 as recorded in database 114 and now has a current participant score of 15 out of 20, the electronic meeting program 110a, 110b may compare the actual delta (e.g., 12 out of 20) between participant P₁'s previous participant score (e.g., 3 out of 20) and participant P₁'s current participant score (e.g., 15 out of 20) and determine that the significant delta threshold (e.g., +/−5 out of 20) is exceeded. Thereafter, the electronic meeting program 110a, 110b may apply the delta factor weight increase of 10% to participant P₁'s current participant score of 15 out of 20.

If the electronic meeting program 110a, 110b determines that a participant's previous participant score does not need to be adjusted in view of the participant's current participant score at 318, or after the electronic meeting program 110a, 110b adjusted the participant's previous participant score in view of the participant's current participant score at 320, then the electronic meeting program 110a, 110b determines the updated meeting effectiveness score of a group of participants at 322. When there are multiple participants, the calculation of the updated meeting effectiveness score may include one or more previous participant scores (in response to determining that the participant's previous participant score does not need to be adjusted), one or more current participant scores (in response to determining that the participant's previous participant score does need to be adjusted), or a combination of both. The electronic meeting program 110a, 110b may aggregate the participant scores of the group of participants to determine the updated meeting effectiveness score in a manner similar to the process at 314.

Then at 324, the updated meeting effectiveness score is graphically displayed on the moderator's display. The electronic meeting program 110a, 110b may send the resulting current, updated meeting effectiveness score to the moderator's device (e.g., desktop) via communication network 116, and render the numeric value of the updated meeting effectiveness score into a graphical meter (FIG. 4) on the moderator's display in a manner similar to the process at 314.

At 326, the electronic meeting program 110a, 110b determines if the electronic meeting has ended. The electronic meeting program 110a, 110b may determine that the electronic meeting has ended if the moderator has reached the end of the moderator's presentation or the moderator otherwise indicates that the presentation is over. If the electronic meeting program 110a, 110b determines that the electronic meeting has not ended, the electronic meeting program 110a, 110b may return to 316 to track each participant's physical markers.

Referring now to FIG. 4, an exemplary illustration of an electronic meeting graphical user interface (GUI) 400 according to at least one embodiment is depicted. The electronic meeting program 110a, 110b may transmit data via communication network 116 to the moderator's device (e.g., desktop) and GUI 400 may render the received data onto a display of the moderator's device. GUI 400 may have a program window 402 including a presentation frame 404 for displaying a meeting content (e.g., the moderator's presentation) and one or more feedback components 406a-406d for displaying graphical representations of various audience feedback metrics.

In embodiments, program window 402 of GUI 400 may be bifurcated or otherwise divided between the presentation frame 404 and the feedback components 406a-406d. In such embodiments, the moderator's presentation or other content shared during the electronic meeting may be contained within presentation frame 404 and feedback components 406a-406d may remain docked and visible to the moderator independent of events occurring within presentation frame 404.

For example, if the moderator uses an action button 408 to move from page 1 to page 5 of the moderator's presentation, the event may only change objects within presentation frame 404, leaving feedback components 406a-406d docked and visible to the moderator. Accordingly, the moderator may read the feedback components 406a-406d in order to receive real-time meeting feedback without having to divert attention away from the moderator's presentation.

With continued reference to FIG. 4, in embodiments, the feedback components 406a-406d may include gauges, dials, meters, progress bars, sliders, and other graphic objects suitable for visually depicting various audience metrics. For example, feedback component 406a may include a needle gauge depicting the meeting effectiveness score as described previously with reference to audience analysis process 300 in FIG. 3. Specifically, after the electronic meeting program 110a, 110b determines the baseline meeting effectiveness score, the electronic meeting program 110a, 110b may transmit the resulting score to the moderator's device (e.g., desktop) via communication network 116 as described previously at 314. Then, GUI 400 may render the numeric value of the baseline meeting effectiveness score into feedback component 406a such that the needle gauge moves to visually indicate the baseline meeting effectiveness score. During the length of the electronic meeting, GUI 400 may update feedback component 406a such that the needle gauge moves to visually indicate the updated meeting effectiveness score based on updated data as described previously at 324.

According to at least one embodiment, feedback components 406b, 406c may depict various other aggregate audience metrics representing the engagement level of the participants. The audience metrics may include, for example, participation level or attention span, mood or emotional state, excitement, agreement, and comprehension. The electronic meeting program 110a, 110b may use one or more cognitive inferencing techniques to analyze a participant's physical markers and derive numeric values for these audience metrics. In embodiments, the electronic meeting program 110a, 110b may include a data model stored in database 114 containing one or more engagement vectors represented for example, as the JavaScript Object Notation below:

engagement: {

excitement: value,
mood: value,
attention: value,
agreement: value,
comprehension: value

| | |
|---|---|
| } | [1] |

The engagement vectors in code snippet [1] may include a value along a positive/negative scale, where 1 may be most negative and 20 may be most positive. GUI 400 may render the numeric scale of each engagement vector into graphic objects, such as the needle gauges of feedback components 406b, 406c, to provide visual feedback to the moderator. In embodiments, the engagement vectors may be averaged to derive an overall engagement level score for each participant. The engagement level scores may then be aggregated across all participants and rendered into a real-time engagement meter (not specifically shown in FIG. 4) for the moderator to read. Though FIG. 4 illustrates three graphic meters, GUI 400 may include any suitable number of graphic meters, providing information on various audience metrics. In embodiments, the moderator may customize GUI 400, for example, to define the number of feedback components, the type of feedback components (e.g., gauges, dials, meters, progress bars, sliders), and the position of the feedback components within program window 402. In embodiments, the moderator may also define the audience metrics represented by the feedback components.

According to at least one other embodiment, the electronic meeting program 110a, 110b may provide the moderator with specific prompts or feedback triggered by audience body language indicators. Specifically, feedback component 406d of GUI 400 may include a dialog box or other popup graphic to prompt or nudge the moderator when the electronic meeting program 110a, 110b identifies specific body language indicators exhibited among a pre-defined number of meeting participants. The threshold number of meeting participants for nudging the moderator may be set by the moderator's preference or based on historical data analyzed by the electronic meeting program 110a, 110b.

For example, if a participant tilts their head to the side, the cognitive system may infer confusion, and the moderator may be nudged via feedback component 406d to explain the concept further. If a participant raises their eyebrows, the cognitive system may infer positive engagement, and the moderator may be notified via feedback component 406d that the content is being positively received. If a participant starts rubbing their chin, the cognitive system may infer that the participant is thinking deeply about something, and the moderator may be nudged via feedback component 406d to ask if the participant has a question or comment. If a participant sighs, yawns, walks away from their computer for an extended period of time, turns to their phone, or otherwise looks away (including nodding off to sleep), the cognitive system may infer that the participant is bored and losing interest, and the moderator may be nudged via feedback component 406d to change the pace, style, or focus of the presentation to increase interest. If a participant provides a verbal reaction such as “huh!” or “huh?”, the cognitive system may infer either excitement or question, and the moderator may be nudged via feedback component 406d as appropriate.

It may be appreciated that FIGS. 2-4 provide only an illustration of one embodiment and do not imply any limitations with regard to how different embodiments may be implemented. Many modifications to the depicted embodiment(s) may be made based on design and implementation requirements. One other embodiment may include the electronic meeting program 110a, 110b applying machine learning at the individual meeting participant level to both observe the individual's participant score over time and determine which factors influence the individual's participant score most often, continually adjusting the individual's baseline participant score as a result.

According to another embodiment, the electronic meeting program 110a, 110b may provide the meeting participants with the option to provide explicit feedback to improve the accuracy of the cognitive system over time. Specifically, the electronic meeting program 110a, 110b may use the explicit feedback to learn whether the inferences made by the cognitive system regarding the meeting participant's audience metrics were accurate. The cognitive system may be able to associate an individual's explicit feedback on the electronic meeting with the inferred feedback the cognitive system derived for that same individual. In embodiments, the cognitive system may gather such explicit feedback through one or more of the following: an end of meeting survey, in-meeting feedback buttons (allowing participants to provide real-time feedback of their interest level), and observing the participant's desktop behavior (e.g., frequently navigating away from the electronic meeting program 110a, 110b window).

FIG. 5 is a block diagram 900 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 5. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the electronic meeting program 110a in client computer 102, and the electronic meeting program 110b in network server 112, may be stored on one or more computer-readable tangible storage devices 916 for execution by one or more processors 906 via one or more RAMs 908 (which typically include cache memory). In the embodiment illustrated in FIG. 5, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the electronic meeting program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless Wi-Fi interface cards, or 3G or 4G wireless interface cards or other wired or wireless communication links. The software program 108 and the electronic meeting program 110a in client computer 102 and the electronic meeting program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the electronic meeting program 110a in client computer 102 and the electronic meeting program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

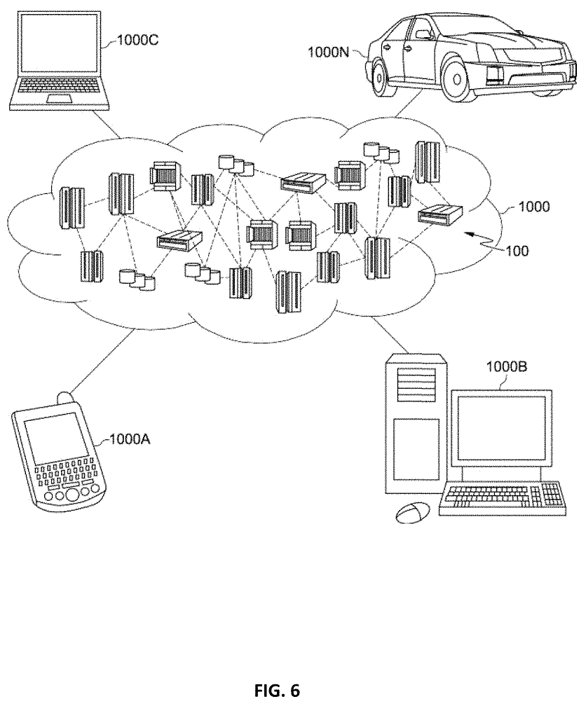

Referring now to FIG. 6, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 6 are intended to be illustrative only and that computing nodes 100 and cloud computing environment 1000 can communicate with any type of computerized device over any type of network and/or network addressable connection (e.g., using a web browser).

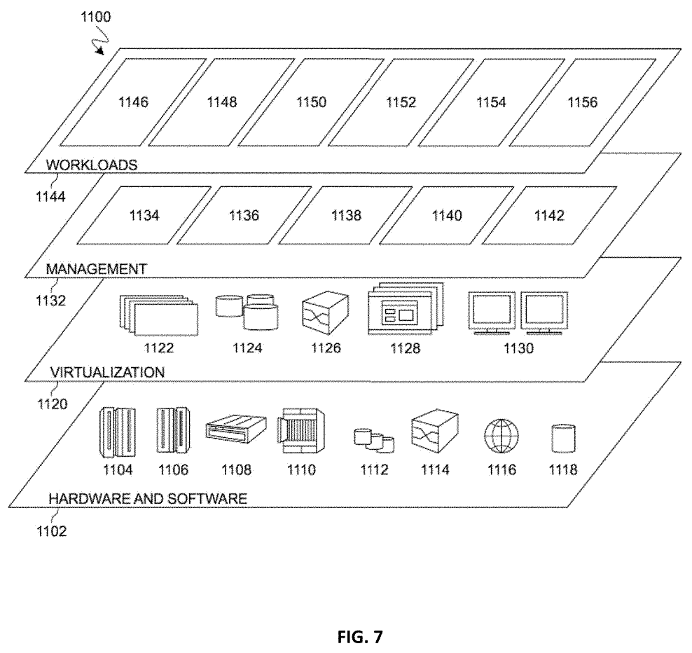

Referring now to FIG. 7, a set of functional abstraction layers 1100 provided by cloud computing environment 1000 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and audience analysis processing 1156. An electronic meeting program 110a, 110b provides a way to determine various audience metrics and graphically deliver the aggregated results in an easily consumable manner to a moderator's display, so that the moderator may receive real-time audience feedback without having to divert attention away from the moderator's presentation.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for automatically evaluating an effectiveness of an electronic meeting based on real-time audience analysis, the method comprising:
receiving, from a device associated with each meeting participant of a plurality of meeting participants in an electronic meeting, a participant data feed having at least one physical marker of the respective meeting participant;
measuring the at least one physical marker of each meeting participant;
deriving, based on the measured at least one physical marker, at least one initial audience metric associated with the meeting participant;
generating a baseline participant score for each meeting participant based on the derived at least one initial audience metric associated with the meeting participant;
evaluating the generated baseline participant score of each meeting participant in view of at least one initial factor;
generating a baseline meeting effectiveness score for the electronic meeting by aggregating the evaluated baseline participant scores of the plurality of meeting participants; and
displaying a graphic representation of the generated baseline meeting effectiveness score of the electronic meeting.

2. The method of claim 1, further comprising:
generating a graphical user interface having a presentation frame including a meeting content and at least one feedback component including the displayed graphic representation of the generated baseline meeting effectiveness score; and
displaying the at least one feedback component simultaneously with the presentation frame.

3. The method of claim 1, wherein evaluating the generated baseline participant score of each meeting participant comprises:
determining that the generated baseline participant score of the meeting participant is impacted by the at least one initial factor; and
adjusting a value of the generated baseline participant score of the meeting participant when aggregating the evaluated baseline participant scores of the plurality of meeting participants.

4. The method of claim 1, further comprising:
deriving a current participant score for each meeting participant based on at least one current audience metric associated with the respective meeting participant;
reevaluating a previous participant score of each meeting participant in view of the derived current participant score of the respective meeting participant; and
determining an updated meeting effectiveness score for the electronic meeting by aggregating the reevaluated previous participant scores of the plurality of meeting participants.

5. The method of claim 3, wherein adjusting the value of the generated baseline participant score of the meeting participant includes adjusting a numerical value of the generated baseline participant score.

6. The method of claim 3, wherein adjusting the value of the generated baseline participant score of the meeting participant includes adjusting a weight value of the generated baseline participant score.

7. The method of claim 4, wherein reevaluating the previous participant score of each meeting participant in view of the derived current participant score comprises:
comparing the previous participant score with the derived current participant score and determining a delta exceeding a pre-determined minimum delta threshold; and
substituting the previous participant score with the derived current participant score of the meeting participant when aggregating the reevaluated previous participant scores of the plurality of meeting participants.

8. The method of claim 4, wherein reevaluating the previous participant score of each meeting participant in view of the derived current participant score comprises:
comparing the previous participant score with the derived current participant score and determining a delta exceeding a pre-determined significant delta threshold; and
adjusting a weight of the derived current participant score of the meeting participant when aggregating the reevaluated previous participant scores of the plurality of meeting participants.

9. A computer system for automatically evaluating an effectiveness of an electronic meeting based on real-time audience analysis, comprising:
one or more processors, one or more computer-readable memories, one or more computer-readable tangible storage media, and program instructions stored on at least one of the one or more computer-readable tangible storage media for execution by at least one of the one or more processors via at least one of the one or more memories, wherein the computer system is capable of performing a method comprising:
receiving, from a device associated with each meeting participant of a plurality of meeting participants in an electronic meeting, a participant data feed having at least one physical marker of the respective meeting participant;
measuring the at least one physical marker of each meeting participant;
deriving, based on the measured at least one physical marker, at least one initial audience metric associated with the meeting participant;
generating a baseline participant score for each meeting participant based on the derived at least one initial audience metric associated with the meeting participant;
evaluating the generated baseline participant score of each meeting participant in view of at least one initial factor;
generating a baseline meeting effectiveness score for the electronic meeting by aggregating the evaluated baseline participant scores of the plurality of meeting participants; and
displaying a graphic representation of the generated baseline meeting effectiveness score of the electronic meeting.

10. The computer system of claim 9, further comprising:
generating a graphical user interface having a presentation frame including a meeting content and at least one feedback component including the displayed graphic representation of the generated baseline meeting effectiveness score; and
displaying the at least one feedback component simultaneously with the presentation frame.

11. The computer system of claim 9, wherein evaluating the generated baseline participant score of each meeting participant comprises:
determining that the generated baseline participant score of the meeting participant is impacted by the at least one initial factor; and
adjusting a value of the generated baseline participant score of the meeting participant when aggregating the evaluated baseline participant scores of the plurality of meeting participants.

12. The computer system of claim 9, further comprising:
deriving a current participant score for each meeting participant based on at least one current audience metric associated with the respective meeting participant;
reevaluating a previous participant score of each meeting participant in view of the derived current participant score of the respective meeting participant; and
determining an updated meeting effectiveness score for the electronic meeting by aggregating the reevaluated previous participant scores of the plurality of meeting participants.

13. The computer system of claim 11, wherein adjusting the value of the generated baseline participant score of the meeting participant includes adjusting a numerical value of the generated baseline participant score.

14. The computer system of claim 11, wherein adjusting the value of the generated baseline participant score of the meeting participant includes adjusting a weight value of the generated baseline participant score.

15. The computer system of claim 12, wherein reevaluating the previous participant score of each meeting participant in view of the derived current participant score comprises:
comparing the previous participant score with the derived current participant score and determining a delta exceeding a pre-determined minimum delta threshold; and
substituting the previous participant score with the derived current participant score of the meeting participant when aggregating the reevaluated previous participant scores of the plurality of meeting participants.

16. The computer system of claim 12, wherein reevaluating the previous participant score of each meeting participant in view of the derived current participant score comprises:
comparing the previous participant score with the derived current participant score and determining a delta exceeding a pre-determined significant delta threshold; and
adjusting a weight of the derived current participant score of the meeting participant when aggregating the reevaluated previous participant scores of the plurality of meeting participants.

17. A computer program product for automatically evaluating an effectiveness of an electronic meeting based on real-time audience analysis, comprising:
one or more computer-readable tangible storage media and program instructions stored on at least one of the one or more computer-readable tangible storage media, the program instructions executable by a processor to cause the processor to perform a method comprising:
receiving, from a device associated with each meeting participant of a plurality of meeting participants in an electronic meeting, a participant data feed having at least one physical marker of the respective meeting participant;
measuring the at least one physical marker of each meeting participant;
deriving, based on the measured at least one physical marker, at least one initial audience metric associated with the meeting participant;
generating a baseline participant score for each meeting participant based on the derived at least one initial audience metric associated with the meeting participant;
evaluating the generated baseline participant score of each meeting participant in view of at least one initial factor;
generating a baseline meeting effectiveness score for the electronic meeting by aggregating the evaluated baseline participant scores of the plurality of meeting participants; and
displaying a graphic representation of the generated baseline meeting effectiveness score of the electronic meeting.

18. The computer program product of claim 17, further comprising:
generating a graphical user interface having a presentation frame including a meeting content and at least one feedback component including the displayed graphic representation of the generated baseline meeting effectiveness score; and
displaying the at least one feedback component simultaneously with the presentation frame.

19. The computer program product of claim 17, wherein evaluating the generated baseline participant score of each meeting participant comprises:
determining that the generated baseline participant score of the meeting participant is impacted by the at least one initial factor; and
adjusting a value of the generated baseline participant score of the meeting participant when aggregating the evaluated baseline participant scores of the plurality of meeting participants.

20. The computer system of claim 17, further comprising:
deriving a current participant score for each meeting participant based on at least one current audience metric associated with the respective meeting participant;
reevaluating a previous participant score of each meeting participant in view of the derived current participant score of the respective meeting participant; and
determining an updated meeting effectiveness score for the electronic meeting by aggregating the reevaluated previous participant scores of the plurality of meeting participants.
